(19) United States
(12) Patent Application Publication
(10) Pub. No.: US 2020/0014241 A1
(43) Pub. Date: Jan. 9, 2020

(54) POWER CONVERSION DEVICE

(71) Applicant: TOSHIBA MITSUBISHI-ELECTRIC INDUSTRIAL SYSTEMS CORPORATION, Chuo-ku (JP)

(72) Inventor: Masaru TOYODA, Chuo-ku (JP)

(73) Assignee: TOSHIBA MITSUBISHI-ELECTRIC INDUSTRIAL SYSTEMS CORPORATION, Chuo-ku (JP)

(21) Appl. No.: 16/489,236

(22) PCT Filed: Apr. 3, 2017
(86) PCT No.: PCT/JP2017/013953

§ 371 Date: Aug. 27, 2019

(51) Int. Cl. H02J 9/06; H02M 7/48

(52) U.S. Cl. CPC H02J 9/062; H02M 7/48

(57) ABSTRACT

A control device of an uninterruptible power supply device is configured to perform a mode selected from a normal operation mode in which a frequency of a triangular wave signal is set to a relatively high frequency and a power saving operation mode in which the frequency of the triangular wave signal is set to a relatively low frequency. Therefore, by selecting the power saving operation mode in the case of driving a load having a large acceptable range for a voltage fluctuation rate of an AC output voltage, switching losses occurring in IGBTs of an inverter can be decreased.

### TECHNICAL FIELD

The present invention relates to a power conversion device, and in particular to a power conversion device including an inversion unit configured to convert direct current (DC) power into alternating current (AC) power.

### BACKGROUND ART

For example, Japanese Patent Laying-Open No. 2008-92734 (PTL 1) discloses a power conversion device including an inversion unit including a plurality of switching elements and configured to convert DC power into AC power having a commercial frequency, and a control device configured to generate a control signal for controlling the plurality of switching elements based on the result of comparison between a sinusoidal signal having the commercial frequency and a triangular wave signal having a frequency fully higher than the commercial frequency. Each of the plurality of switching elements is turned on and off at a frequency with a value according to the frequency of the triangular wave signal.

### CITATION LIST

### Patent Literature

PTL 1: Japanese Patent Laying-Open No. 2008-92734

### SUMMARY OF INVENTION

### Technical Problem

However, a conventional power conversion device has a problem that a switching loss occurs each time a switching element is turned on and off, causing a reduction in the efficiency of the power conversion device.

Accordingly, a main object of the present invention is to provide a highly efficient power conversion device.

### Solution to Problem

A power conversion device in accordance with the present invention includes an inversion unit including a plurality of switching elements and configured to convert DC power into AC power having a commercial frequency and supply the AC power to a load, and a control device configured to compare levels of a sinusoidal signal having the commercial frequency and a triangular wave signal having a frequency higher than the commercial frequency, and generate a control signal for controlling the plurality of switching elements based on a result of comparison. The control device is configured to perform a mode selected from a first mode in which the frequency of the triangular wave signal is set to a first value and a second mode in which the frequency of the triangular wave signal is set to a second value smaller than the first value.

### Advantageous Effects of Invention

In the power conversion device in accordance with the present invention, the mode selected from the first mode in which the frequency of the triangular wave signal is set to the first value and the second mode in which the frequency of the triangular wave signal is set to the second value smaller than the first value is performed. Therefore, by selecting the second mode when the load can be operated in the second mode, switching losses occurring in the plurality of switching elements can be decreased, achieving an improved efficiency of the power conversion device.

### BRIEF DESCRIPTION OF DRAWINGS

FIG. 1 is a circuit block diagram showing a configuration of an uninterruptible power supply device in accordance with a first embodiment of the present invention.

FIG. 2 is a block diagram showing a configuration of a part related to controlling an inverter, of a control device shown in FIG. 1.

FIG. 3 is a circuit block diagram showing a configuration of a gate control circuit shown in FIG. 2.

FIG. 4 is a time chart illustrating waveforms of a voltage command value, a triangular wave signal, and gate signals shown in FIG. 3.

FIG. 5 is a circuit block diagram showing a configuration of the inverter and the periphery thereof shown in FIG. 1.

FIG. 6 is a circuit block diagram showing a modification of the first embodiment.

FIG. 7 is a circuit block diagram showing a main part of an uninterruptible power supply device in accordance with a second embodiment of the present invention.

FIG. 8 is a circuit block diagram showing a configuration of a gate control circuit included in the uninterruptible power supply device shown in FIG. 7.

FIG. 9 is a time chart illustrating waveforms of a voltage command value, triangular wave signals, and gate signals shown in FIG. 8.

FIG. 10 is a circuit block diagram showing a modification of the second embodiment.

### DESCRIPTION OF EMBODIMENTS

### First Embodiment

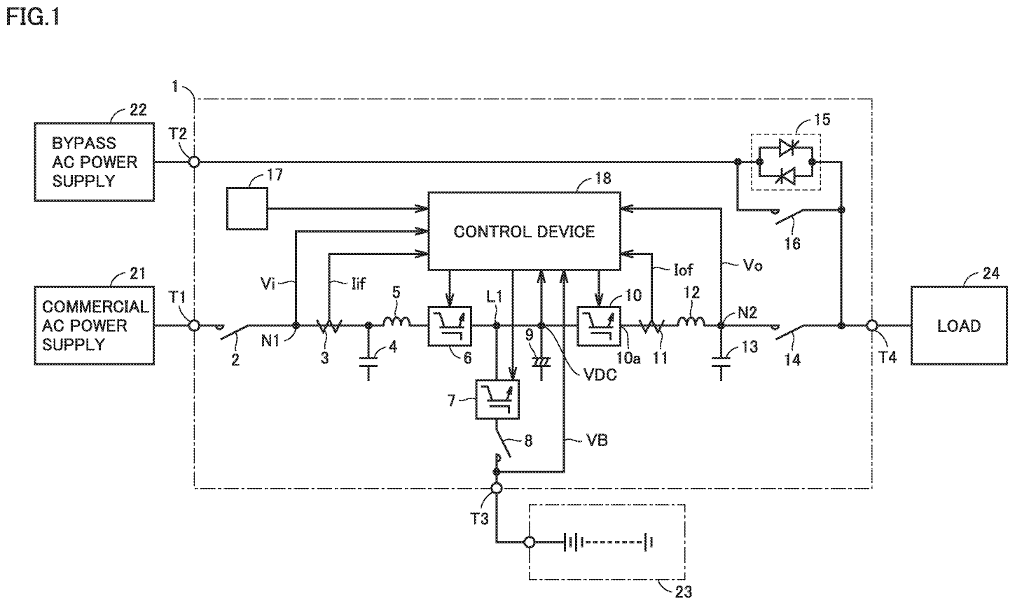

FIG. 1 is a circuit block diagram showing a configuration of an uninterruptible power supply device 1 in accordance with a first embodiment of the present invention. Uninterruptible power supply device 1 is configured to temporarily convert three-phase AC power from a commercial AC power supply 21 into DC power, convert the DC power into three-phase AC power, and supply the three-phase AC power to a load 24. For simplification of the drawing and the description, FIG. 1 shows only a circuit of a part corresponding to one phase (for example, U phase) of three phases (U phase, V phase, W phase).

In FIG. 1, uninterruptible power supply device 1 includes an AC input terminal T1, a bypass input terminal T2, a battery terminal T3, and an AC output terminal T4. AC input terminal Ti receives AC power having a commercial frequency from commercial AC power supply 21. Bypass input terminal T2 receives AC power having the commercial frequency from a bypass AC power supply 22. Bypass AC power supply 22 may be a commercial AC power supply, or may be a power generator.

Battery terminal T3 is connected to a battery (power storage device) 23. Battery 23 stores DC power. A capacitor may be connected instead of battery 23. AC output terminal T4 is connected to load 24. Load 24 is driven by AC power.

Uninterruptible power supply device 1 further includes electromagnetic contactors 2, 8, 14, and 16, current detectors 3 and 11, capacitors 4, 9, and 13, reactors 5 and 12, a converter 6, a bidirectional chopper 7, an inverter 10, a semiconductor switch 15, an operation unit 17, and a control device 18.

Electromagnetic contactor 2 and reactor 5 are connected in series between AC input terminal T1 and an input node of converter 6. Capacitor 4 is connected to a node N1 between electromagnetic contactor 2 and reactor 5. Electromagnetic contactor 2 is turned on during use of uninterruptible power supply device 1, and is turned off during maintenance of uninterruptible power supply device 1, for example.

An instantaneous value of an AC input voltage Vi appearing at node N1 is detected by control device 18. Whether or not a power failure has occurred and the like are determined based on the instantaneous value of AC input voltage Vi. Current detector 3 detects an AC input current Ii flowing to node N1, and provides a signal Iif indicating a detection value thereof to control device 18.

Capacitor 4 and reactor 5 constitute a low pass filter, which passes the AC power having the commercial frequency from commercial AC power supply 21 to converter 6, and prevents passage of a signal having a switching frequency generated in converter 6 to commercial AC power supply 21.

Converter 6 is controlled by control device 18. During a normal state in which the AC power is supplied from commercial AC power supply 21, converter 6 converts the AC power into DC power and outputs the DC power to a DC line L1. During a power failure in which the supply of the AC power from commercial AC power supply 21 is stopped, operation of converter 6 is stopped. An output voltage of converter 6 can be controlled to a desired value. Capacitor 4, reactor 5, and converter 6 constitute a conversion unit.

Capacitor 9 is connected to DC line L1 to smooth a voltage in DC line L1. An instantaneous value of a DC voltage VDC appearing in DC line L1 is detected by control device 18. DC line L1 is connected to a high voltage-side node of bidirectional chopper 7, and a low voltage-side node of bidirectional chopper 7 is connected to battery terminal T3 via electromagnetic contactor 8.

Electromagnetic contactor 8 is turned on during use of uninterruptible power supply device 1, and is turned off during maintenance of uninterruptible power supply device 1 and battery 23, for example. An instantaneous value of a voltage VB between terminals of battery 23 appearing at battery terminal T3 is detected by control device 18.

Bidirectional chopper 7 is controlled by control device 18. During a normal state in which the AC power is supplied from commercial AC power supply 21, bidirectional chopper 7 stores the DC power generated by converter 6 in battery 23. During a power failure in which the supply of the AC power from commercial AC power supply 21 is stopped, bidirectional chopper 7 supplies the DC power in battery 23 to inverter 10 via DC line L1.

When bidirectional chopper 7 stores the DC power in battery 23, bidirectional chopper 7 steps down DC voltage VDC in DC line L1 and provides it to battery 23. In addition, when bidirectional chopper 7 supplies the DC power in battery 23 to inverter 10, bidirectional chopper 7 boosts voltage VB between the terminals of battery 23 and outputs it to DC line L1. DC line L1 is connected to an input node of inverter 10.

Inverter 10 is controlled by control device 18, and converts the DC power supplied from converter 6 or bidirectional chopper 7 via DC line L1 into AC power having the commercial frequency and outputs the AC power. That is, during a normal state, inverter 10 converts the DC power supplied from converter 6 via DC line L1 into AC power, and during a power failure, inverter 10 converts the DC power supplied from battery 23 via bidirectional chopper 7 into AC power. An output voltage of inverter 10 can be controlled to a desired value.

An output node 10a of inverter 10 is connected to one terminal of reactor 12, and the other terminal of reactor 12 (a node N2) is connected to AC output terminal T4 via electromagnetic contactor 14. Capacitor 13 is connected to node N2.

Current detector 11 detects an instantaneous value of an output current Io of inverter 10, and provides a signal Iof indicating a detection value thereof to control device 18. An instantaneous value of an AC output voltage Vo appearing at node N2 is detected by control device 18.

Reactor 12 and capacitor 13 constitute a low pass filter, which passes the AC power having the commercial frequency generated in inverter 10 to AC output terminal T4, and prevents passage of a signal having a switching frequency generated in inverter 10 to AC output terminal T4. Inverter 10, reactor 12, and capacitor 13 constitute an inversion unit.

Electromagnetic contactor 14 is controlled by control device 18. Electromagnetic contactor 14 is turned on during an inverter power feeding mode in which the AC power generated by inverter 10 is fed to load 24, and is turned off during a bypass power feeding mode in which the AC power from bypass AC power supply 22 is fed to load 24.

Semiconductor switch 15 includes a thyristor, and is connected between bypass input terminal T2 and AC output terminal T4. Electromagnetic contactor 16 is connected in parallel with semiconductor switch 15. Semiconductor switch 15 is controlled by control device 18. Semiconductor switch 15 is usually turned off, and, when inverter 10 has a failure, semiconductor switch 15 is instantaneously turned on to supply the AC power from bypass AC power supply 22 to load 24. Semiconductor switch 15 is turned off after a predetermined time has elapsed since it was turned on.

Electromagnetic contactor 16 is turned off during the inverter power feeding mode in which the AC power generated by inverter 10 is fed to load 24, and is turned on during the bypass power feeding mode in which the AC power from bypass AC power supply 22 is fed to load 24.

In addition, when inverter 10 has a failure, electromagnetic contactor 16 is turned on to supply the AC power from bypass AC power supply 22 to load 24. That is, when inverter 10 has a failure, semiconductor switch 15 is instantaneously turned on only for the predetermined time, and electromagnetic contactor 16 is also turned on. This is to prevent semiconductor switch 15 from being overheated and damaged.

Operation unit 17 includes a plurality of buttons to be operated by a user of uninterruptible power supply device 1, an image display unit for displaying various pieces of information, and the like. By operating operation unit 17, the user can power on and off uninterruptible power supply device 1, can select one of the bypass power feeding mode and the inverter power feeding mode, and can select one of a normal operation mode (a first mode) described later and a power saving operation mode (a second mode) described later.

Control device 18 controls entire uninterruptible power supply device 1 based on a signal from operation unit 17, AC input voltage Vi, AC input current Iif, DC voltage VDC, battery voltage VB, AC output current Iof, AC output voltage Vo, and the like. That is, control device 18 detects whether or not a power failure has occurred based on a detection value of AC input voltage Vi, and controls converter 6 and inverter 10 in synchronization with the phase of AC input voltage Vi.

Further, during a normal state in which the AC power is supplied from commercial AC power supply 21, control device 18 controls converter 6 such that DC voltage VDC becomes equal to a desired target DC voltage VDCT, and during a power failure in which the supply of the AC power from commercial AC power supply 21 is stopped, control device 18 stops operation of converter 6.

Further, during a normal state, control device 18 controls bidirectional chopper 7 such that battery voltage VB becomes equal to a desired target battery voltage VBT, and during a power failure, control device 18 controls bidirectional chopper 7 such that DC voltage VDC becomes equal to desired target DC voltage VDCT.

Further, when the normal operation mode is selected using operation unit 17, control device 18 compares levels of a sinusoidal signal having the commercial frequency and a triangular wave signal having a frequency fH fully higher than the commercial frequency, and generates a plurality of gate signals (control signals) for controlling inverter 10 based on the result of comparison.

Further, when the power saving operation mode is selected using operation unit 17, control device 18 compares levels of the sinusoidal signal having the commercial frequency and a triangular wave signal having a frequency fL lower than frequency fH, and generates a plurality of gate signals for controlling inverter 10 based on the result of comparison.

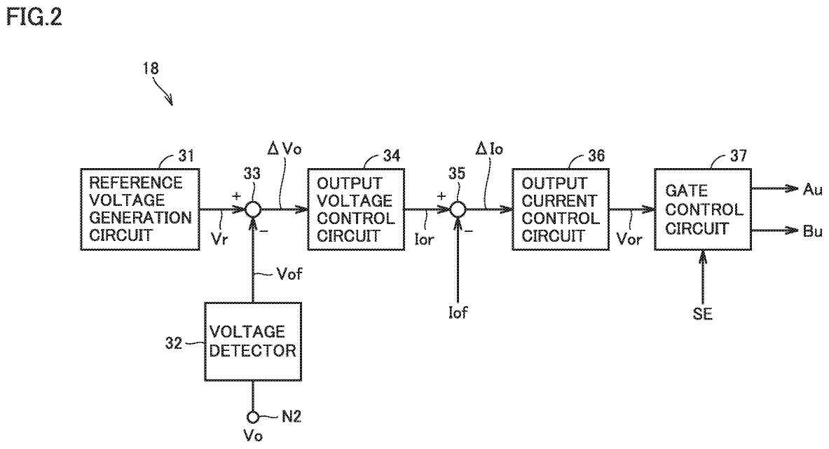

FIG. 2 is a block diagram showing a configuration of a part related to controlling the inverter, of the control device shown in FIG. 1. In FIG. 2, control device 18 includes a reference voltage generation circuit 31, a voltage detector 32, subtractors 33 and 35, an output voltage control circuit 34, an output current control circuit 36, and a gate control circuit 37.

Reference voltage generation circuit 31 generates a reference voltage Vr which is a sinusoidal signal having the commercial frequency. The phase of reference voltage Vr is in synchronization with the phase of AC input voltage Vi for a corresponding phase (here, U phase) of the three phases (U phase, V phase, W phase).

Voltage detector 32 detects the instantaneous value of AC output voltage Vo at node N2 (FIG. 1), and outputs a signal Vof indicating a detection value. Subtractor 33 obtains a deviation ΔVo between reference voltage Vr and output signal Vof of voltage detector 32.

Output voltage control circuit 34 adds a value proportional to deviation ΔVo to an integrated value of deviation ΔVo, to generate a current command value Ior. Subtractor 35 obtains a deviation ΔIo between current command value Ior and signal Iof from current detector 11. Output current control circuit 36 adds a value proportional to deviation ΔIo to an integrated value of deviation ΔIo, to generate a voltage command value Vor. Voltage command value Vor is a sinusoidal signal having the commercial frequency.

Gate control circuit 37 generates gate signals Au and Bu (control signals) for controlling inverter 10 for the corresponding phase (here, U phase), according to a mode selection signal SE from operation unit 17 (FIG. 1). Mode selection signal SE is set to an “H” level during the normal operation mode, and is set to an “L” level during the power saving operation mode, for example.

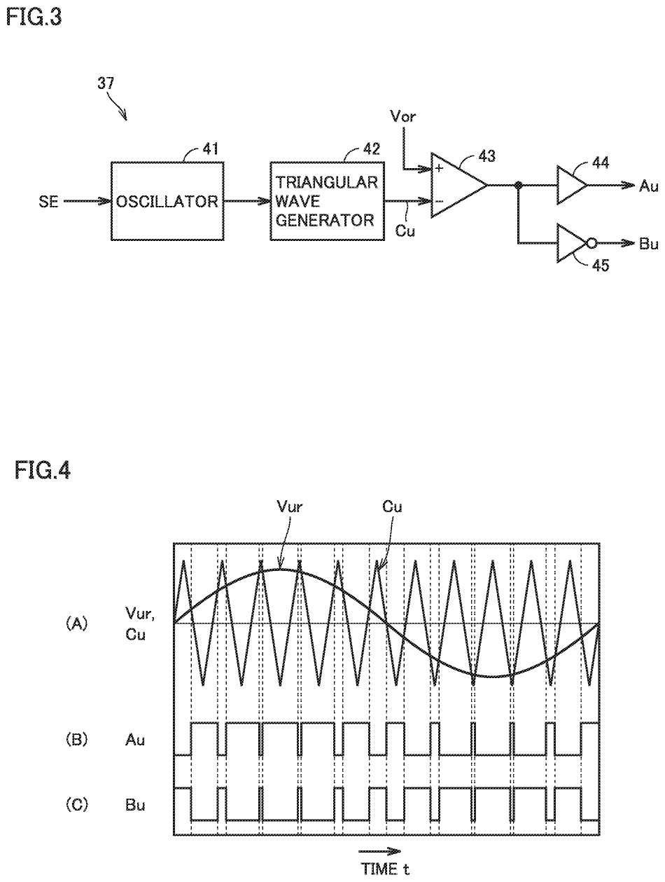

FIG. 3 is a circuit block diagram showing a configuration of gate control circuit 37. In FIG. 3, gate control circuit 37 includes an oscillator 41, a triangular wave generator 42, a comparator 43, a buffer 44, and an inverter 45.

Oscillator 41 is an oscillator capable of controlling the frequency of an output clock signal (for example, a voltage-controlled oscillator). When mode selection signal SE is at the “H” level, oscillator 41 outputs a clock signal having frequency fH (for example, 20 KHz) fully higher than the commercial frequency (for example, 60 Hz), and when mode selection signal SE is at the “L” level, oscillator 41 outputs a clock signal having frequency fL (for example, 15 KHz) lower than frequency fH. Triangular wave generator 42 outputs a triangular wave signal Cu having the same frequency as that of the output clock signal of the oscillator.

Comparator 43 compares levels of voltage command value Vor from output current control circuit 36 (FIG. 2) and triangular wave signal Cu from triangular wave generator 42, and outputs gate signal Au indicating the result of comparison. Buffer 44 provides gate signal Au to inverter 10. Inverter 45 inverts gate signal Au to generate gate signal Bu and provides gate signal Bu to inverter 10.

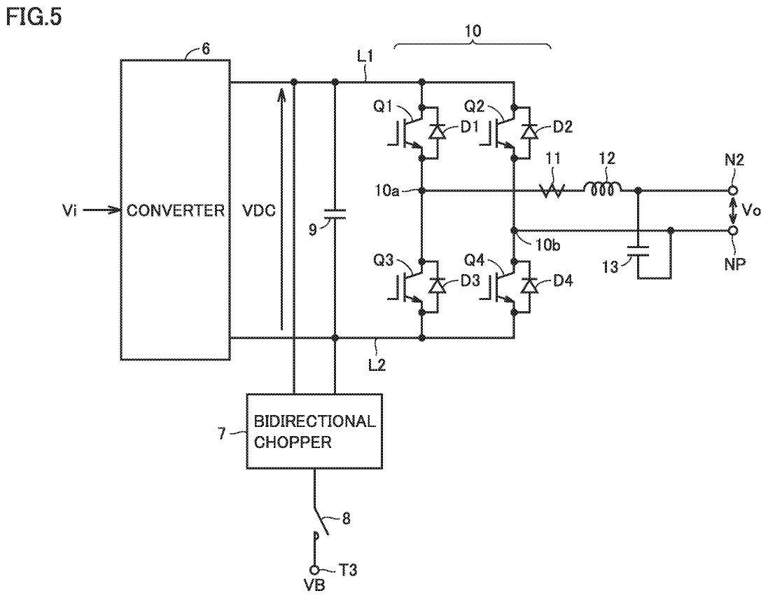

FIGS. 4(A), (B), and (C) show a time chart showing waveforms of voltage command value Vor, triangular wave signal Cu, and gate signals Au and Bu shown in FIG. 3. As shown in FIG. 4(A), voltage command value Vor is a sinusoidal signal having the commercial frequency. The frequency of triangular wave signal Cu is higher than the frequency (commercial frequency) of voltage command value Vor. A peak value of triangular wave signal Cu on the positive side is higher than a peak value of voltage command value Vor on the positive side. A peak value of triangular wave signal Cu on the negative side is lower than a peak value of voltage command value Vor on the negative side.

As shown in FIGS. 4(A) and (B), when the level of triangular wave signal Cu is higher than the level of voltage command value Vor, gate signal Au is at an “L” level, and when the level of triangular wave signal Cu is lower than the level of voltage command value Vor, gate signal Au is at an “H” level. Gate signal Au is a positive pulse signal sequence.

During a period in which voltage command value Vor has positive polarity, the pulse width of gate signal Au increases as voltage command value Vor increases. During a period in which voltage command value Vor has negative polarity, the pulse width of gate signal Au decreases as voltage command value Vor decreases. As shown in FIGS. 4(B) and (C), gate signal Bu is an inverted signal of gate signal Au. Each of gate signals Au and Bu is a PWM (Pulse Width Modulation) signal.

FIG. 5 is a circuit block diagram showing a configuration of inverter 10 and the periphery thereof shown in FIG. 1. In FIG. 5, positive-side DC line L1 and a negative-side DC line L2 are connected between converter 6 and inverter 10. Capacitor 9 is connected between DC lines L1 and L2.

During a normal state in which the AC power is supplied from commercial AC power supply 21, converter 6 converts AC input voltage Vi from commercial AC power supply 21 into DC voltage VDC and outputs DC voltage VDC to between DC lines L1 and L2. During a power failure in which the supply of the AC power from commercial AC power supply 21 is stopped, operation of converter 6 is stopped, and bidirectional chopper 7 boosts battery voltage VB and outputs DC voltage VDC to between DC lines L1 and L2.

Inverter 10 includes IGBTs (Insulated Gate Bipolar Transistors) Q1 to Q4 and diodes D1 to D4. An IGBT constitutes a switching element. IGBTs Q1 and Q2 have collectors connected to DC line L1, and emitters connected to output nodes 10a and 10b, respectively.

IGBTs Q3 and Q4 have collectors connected to output nodes 10a and 10b, respectively, and emitters connected to DC line L2. Gates of IGBTs Q1 and Q4 receive gate signal Au, and gates of IGBTs Q2 and Q3 receive gate signal Bu. Diodes D1 to D4 are connected in anti-parallel with IGBTs Q1 to Q4, respectively.

Inverter 10 has output node 10a connected to node N2 via reactor 12 (FIG. 1), and output node 10b connected to a neutral point NP. Capacitor 13 is connected between node N2 and neutral point NP.

When gate signals Au and Bu are at the “H” level and the “L” level, respectively, IGBTs Q1 and Q4 are turned on and IGBTs Q2 and Q3 are turned off. Thereby, a positive-side terminal of capacitor 9 (DC line L1) is connected to output node 10a via IGBT Q1, and output node 10b is connected to a negative-side terminal of capacitor 9 (DC line L2) via IGBT Q4, and thus a voltage between the terminals of capacitor 9 is output to between output nodes 10a and 10b. That is, a positive DC voltage is output to between output nodes 10a and 10b.

When gate signals Au and Bu are at the “L” level and the “H” level, respectively, IGBTs Q2 and Q3 are turned on and IGBTs Q1 and Q4 are turned off. Thereby, the positive-side terminal of capacitor 9 (DC line L1) is connected to output node 10b via IGBT Q2, and output node 10a is connected to the negative-side terminal of capacitor 9 (DC line L2) via IGBT Q3, and thus the voltage between the terminals of capacitor 9 is output to between output nodes 10b and 10a. That is, a negative DC voltage is output to between output nodes 10a and 10b.

When the waveforms of gate signals Au and Bu change as shown in FIGS. 4(B) and (C), AC output voltage Vo having the same waveform as that of voltage command value Vur shown in FIG. 4(A) is output to between node N2 and neutral point NP. It should be noted that, although FIGS. 4(A), (B), and (C) show the waveforms of voltage command value Vur and signals Cu, Au, and Bu corresponding to the U phase, the same applies to the waveforms of the voltage command value and the signals corresponding to each of the V phase and the W phase. However, the voltage command values and the signals corresponding to the U phase, the V phase, and the W phase are out of phase with respect to each other by 120 degrees.

As can be seen from FIGS. 4(A), (B), and (C), when the frequency of triangular wave signal Cu is increased, the frequency of gate signals Au and Bu increases, and the switching frequency of IGBTs Q1 to Q4 (the number of times of turning on and off per second) increases. When the switching frequency of IGBTs Q1 to Q4 increases, switching losses occurring in IGBTs Q1 to Q4 increase, causing a reduction in the efficiency of uninterruptible power supply device 1. However, when the switching frequency of IGBTs Q1 to Q4 increases, a voltage fluctuation rate of AC output voltage Vo decreases, and high-quality AC output voltage Vo is obtained.

In contrast, when the frequency of triangular wave signal Cu is decreased, the frequency of gate signals Au and Bu decreases, and the switching frequency of IGBTs Q1 to Q4 decreases. When the switching frequency of IGBTs Q1 to Q4 decreases, switching losses occurring in IGBTs Q1 to Q4 decrease, achieving an improved efficiency of uninterruptible power supply device 1. However, when the switching frequency of IGBTs Q1 to Q4 decreases, the voltage fluctuation rate of AC output voltage Vo increases, and the waveform of AC output voltage Vo is deteriorated.

A voltage fluctuation rate of an AC voltage is indicated, for example, by a fluctuation range of the AC voltage on the basis of a rated voltage (100%). A voltage fluctuation rate of AC input voltage Vi supplied from commercial AC power supply 21 (FIG. 1) is ±10% on the basis of the rated voltage.

In a conventional uninterruptible power supply device, the frequency of triangular wave signal Cu is fixed to frequency fH (for example, 20 KHz) fully higher than the commercial frequency (for example, 60 Hz) to suppress a voltage fluctuation rate to a small value (±2%). Thus, load 24 having a small acceptable range for the voltage fluctuation rate (for example, a computer) can be driven. On the other hand, relatively large switching losses occur in IGBTs Q1 to Q4, causing a reduction in the efficiency of the uninterruptible power supply device.

However, in the case of driving a load which has a large acceptable range for the voltage fluctuation rate and can be driven by AC input voltage Vi from commercial AC power supply 21 (for example, a fan, a processing machine), the frequency of triangular wave signal Cu can be set to frequency fL (for example, 15 KHz) lower than frequency fH to reduce switching losses occurring in IGBTs Q1 to Q4. Frequency fL is set to a value at which the voltage fluctuation rate of AC output voltage Vo is less than or equal to the voltage fluctuation rate of AC input voltage Vi from commercial AC power supply 21.

Accordingly, in the first embodiment, there are provided the normal operation mode in which the frequency of triangular wave signal Cu is set to relatively high frequency fH to decrease the voltage fluctuation rate, and the power saving operation mode in which the frequency of triangular wave signal Cu is set to relatively low frequency fL to decrease switching losses. The user of uninterruptible power supply device 1 can select a desired mode from the normal operation mode and the power saving operation mode, according to the type of load 24.

Next, a method of using uninterruptible power supply device 1 and operation thereof will be described. First, a description will be given of a case where load 24 is a load having a small acceptable range for the voltage fluctuation rate (that is, a load which cannot be driven by AC input voltage Vi from commercial AC power supply 21).

In this case, the user of uninterruptible power supply device 1 uses an AC power supply in which an AC output voltage has a small voltage fluctuation rate, as bypass AC power supply 22, and operates operation unit 17 to select the inverter power feeding mode and the normal operation mode.

When the inverter power feeding mode is selected during a normal state in which the AC power is supplied from commercial AC power supply 21, semiconductor switch 15 and electromagnetic contactor 16 are turned off, and electromagnetic contactors 2, 8, and 14 are turned on.

The AC power supplied from commercial AC power supply 21 is converted into DC power by converter 6. The DC power generated by converter 6 is stored in battery 23 by bidirectional chopper 7, and is also supplied to inverter 10.

In control device 18 (FIG. 2), sinusoidal reference voltage Vr is generated by reference voltage generation circuit 31, and signal Vof indicating the detection value of AC output voltage Vo is generated by voltage detector 32. Deviation ΔVo between reference voltage Vr and signal Vof is generated in subtractor 33, and current command value Ior is generated by output voltage control circuit 34 based on deviation ΔVo.

Deviation ΔIo between current command value Ior and signal Iof from current detector 11 (FIG. 1) is generated by subtractor 35, and voltage command value Vor is generated by output current control circuit 36 based on deviation ΔIo.

Since the normal operation mode is selected and mode selection signal SE is set to the “H” level, in gate control circuit 37 (FIG. 3), triangular wave signal Cu having relatively high frequency fH is generated by oscillator 41 and triangular wave generator 42. Voltage command value Vor is compared with triangular wave signal Cu by comparator 43, and gate signals Au and Bu are generated by buffer 44 and inverter 45.

In inverter 10 (FIG. 5), IGBTs Q1 and Q4 and IGBTs Q2 and Q3 are alternately turned on by gate signals Au and Bu, and DC voltage VDC is converted into AC output voltage Vo having the commercial frequency.

Since each of IGBTs Q1 to Q4 is turned on and off at relatively high frequency fH in the normal operation mode, high-quality AC output voltage Vo having a small voltage fluctuation rate can be generated. However, switching losses occurring in IGBTs Q1 to Q4 increase, causing a reduction in efficiency.

It should be noted that, when the supply of the AC power from commercial AC power supply 21 is stopped, that is, when a power failure occurs, operation of converter 6 is stopped, and the DC power in battery 23 (FIG. 1) is supplied to inverter 10 by bidirectional chopper 7. Inverter 10 converts the DC power from bidirectional chopper 7 into AC power, and supplies the AC power to load 24. Therefore, operation of load 24 can be continued for a period in which the DC power is stored in battery 23.

In addition, when inverter 10 has a failure during the inverter power feeding mode, semiconductor switch 15 is instantaneously turned on, electromagnetic contactor 14 is turned off, and electromagnetic contactor 16 is turned on. Thereby, the AC power from bypass AC power supply 22 is supplied to load 24 via semiconductor switch 15 and electromagnetic contactor 16, and operation of load 24 is continued. Semiconductor switch 15 is turned off after the predetermined time to prevent semiconductor switch 15 from being overheated and damaged.

Next, a description will be given of a case where load 24 is a load having a large acceptable range for the voltage fluctuation rate (that is, a load which can be driven by AC input voltage Vi from commercial AC power supply 21). In this case, the user of uninterruptible power supply device 1 uses commercial AC power supply 21 as bypass AC power supply 22, and operates operation unit 17 to select the inverter power feeding mode and the power saving operation mode.

Since the power saving operation mode is selected and mode selection signal SE is set to the “L” level, in gate control circuit 37 (FIG. 3), triangular wave signal Cu having relatively low frequency fL is generated by oscillator 41 and triangular wave generator 42. Voltage command value Vor is compared with triangular wave signal Cu by comparator 43, and gate signals Au and Bu are generated by buffer 44 and inverter 45.

In inverter 10 (FIG. 5), IGBTs Q1 and Q4 and IGBTs Q2 and Q3 are alternately turned on by gate signals Au and Bu, and DC voltage VDC is converted into AC output voltage Vo having the commercial frequency.

Since each of IGBTs Q1 to Q4 is turned on and off at relatively low frequency fL in the power saving operation mode, the voltage fluctuation rate of AC output voltage Vo relatively increases. However, since load 24 having a large acceptable range for the voltage fluctuation rate of AC output voltage Vo is driven, load 24 can be driven without problems even when the voltage fluctuation rate of AC output voltage Vo increases. In addition, switching losses occurring in IGBTs Q1 to Q4 decrease, achieving an improved efficiency. Since operation when a power failure occurs and operation when inverter 10 has a failure are the same as operation during the normal operation mode, the description thereof will not be repeated.

As described above, in the first embodiment, there are provided the normal operation mode in which the frequency of triangular wave signal Cu is set to relatively high frequency fH, and the power saving operation mode in which the frequency of triangular wave signal Cu is set to relatively low frequency fL, and a selected mode is performed. Therefore, by selecting the power saving operation mode in the case of driving load 24 having a large acceptable range for the voltage fluctuation rate of AC output voltage Vo, switching losses occurring in IGBTs Q1 to Q4 of inverter 10 can be decreased, achieving an improved efficiency of uninterruptible power supply device 1.

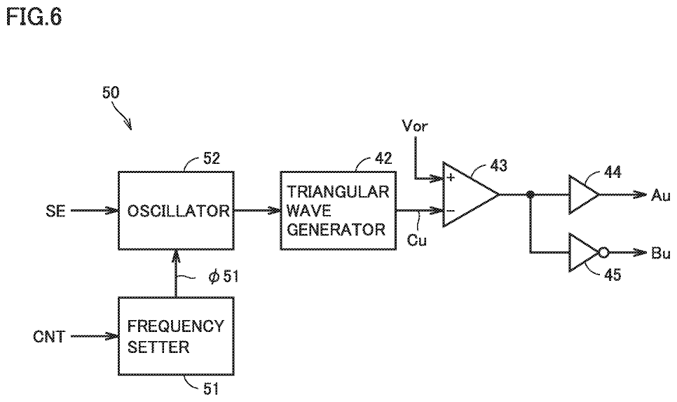

FIG. 6 is a circuit block diagram showing a modification of the first embodiment, which is compared with FIG. 3. This modification is different from the first embodiment in that a gate control circuit 50 replaces gate control circuit 37. In gate control circuit 50, a frequency setter 51 and an oscillator 52 replace oscillator 41 of gate control circuit 37.

In this modification, frequency fL of triangular wave signal Cu in the power saving operation mode can be set to a desired value by operating operation unit 17. Frequency setter 51 outputs a signal ϕ51 indicating set frequency fL, based on a control signal CNT from operation unit 17.

When mode selection signal SE is at the “H” level, oscillator 52 outputs a clock signal having relatively high frequency fH, and when mode selection signal SE is at the “L” level, oscillator 52 outputs a clock signal having frequency fL designated by signal ϕ51. Triangular wave generator 42 outputs triangular wave signal Cu having the same frequency as that of the output clock signal of oscillator 52. In this modification, the same effect as that of the first embodiment is obtained, and in addition, frequency fL of triangular wave signal Cu in the power saving operation mode can be set to a desired value, according to the type of load 24.

### Second Embodiment

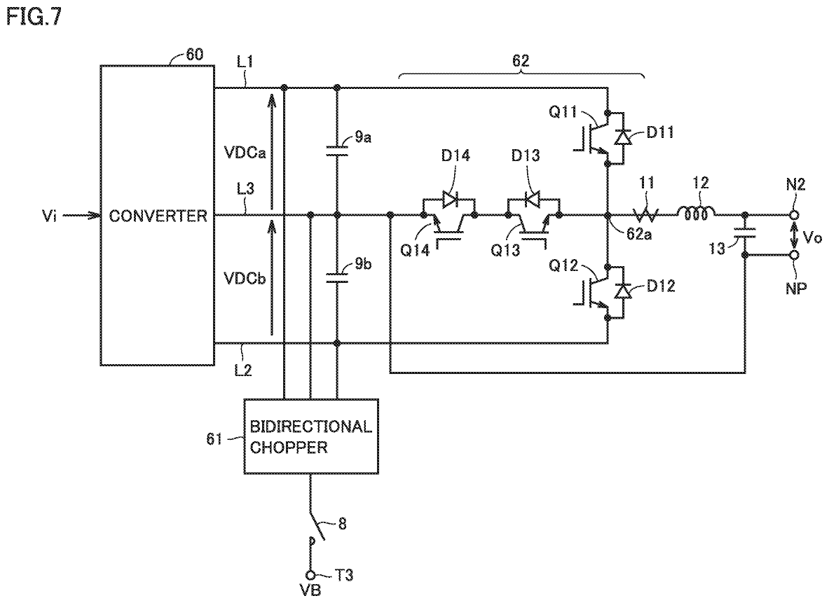

FIG. 7 is a circuit block diagram showing a main part of an uninterruptible power supply device in accordance with a second embodiment of the present invention, which is compared with FIG. 5. In FIG. 7, this uninterruptible power supply device is different from uninterruptible power supply device 1 in the first embodiment in that a converter 60, a bidirectional chopper 61, and an inverter 62 replace converter 6, bidirectional chopper 7, and inverter 10, respectively.

Three DC lines L1 to L3 are connected between converter 60 and inverter 62. DC line L3 is connected to neutral point NP, and has a neutral point voltage (for example, 0 V). Capacitor 9 (FIG. 1) includes two capacitors 9a and 9b. Capacitor 9a is connected between DC lines L1 and L3. Capacitor 9b is connected between DC lines L3 and L2.

During a normal state in which the AC power is supplied from commercial AC power supply 21, converter 60 converts the AC power from commercial AC power supply 21 into DC power and supplies the DC power to DC lines L1 to L3. On this occasion, converter 60 charges each of capacitors 9a and 9b such that a DC voltage VDCa between DC lines L1 and L3 becomes equal to target DC voltage VDCT and a DC voltage VDCb between DC lines L3 and L2 becomes equal to target DC voltage VDCT.

Voltages in DC lines L1, L2, and L3 are set to a positive DC voltage, a negative DC voltage, and the neutral point voltage, respectively. During a power failure in which the supply of the AC power from commercial AC power supply 21 is stopped, operation of converter 60 is stopped.

During a normal state, bidirectional chopper 61 stores the DC power generated by converter 60 in battery 23 (FIG. 1). On this occasion, bidirectional chopper 61 charges battery 23 such that voltage VB between the terminals of battery 23 (battery voltage VB) becomes equal to target battery voltage VBT.

During a power failure, bidirectional chopper 61 supplies the DC power in battery 23 to inverter 62. On this occasion, bidirectional chopper 61 charges each of capacitors 9a and 9b such that each of voltage VDCa between terminals of capacitor 9a and voltage VDCb between terminals of capacitor 9b becomes equal to target DC voltage VDCT.

During a normal state, inverter 62 converts the DC power generated by converter 60 into AC power having the commercial frequency, and supplies the AC power to load 24 (FIG. 1). On this occasion, inverter 62 generates AC output voltage Vo having the commercial frequency, based on the positive DC voltage, the negative DC voltage, and the neutral point voltage supplied from DC lines L1 to L3.

Inverter 62 includes IGBTs Q11 to Q14 and diodes D11 to D14. IGBT Q11 has a collector connected to DC line L1, and an emitter connected to an output node 62a. IGBT Q12 has a collector connected to output node 62a, and an emitter connected to DC line L2. IGBTs Q13 and Q14 have collectors connected with each other, and emitters connected to output node 62a and DC line L3, respectively. Diodes D11 to D14 are connected in anti-parallel with IGBTs Q11 to Q14, respectively. Output node 62a is connected to node N2 via reactor 12 (FIG. 1).

When IGBT Q11 is turned on, the positive voltage is output from DC line L1 to output node 62a via IGBT Q11. When IGBTs Q13 and Q14 are turned on, the neutral point voltage is output from DC line L3 to output node 62a via IGBTs Q14 and Q13. When IGBT Q12 is turned on, the negative voltage is output from DC line L2 to output node 62a via IGBT Q12. An AC voltage having three levels including the positive voltage, the neutral point voltage, and the negative voltage is output to output node 62a. A method for controlling IGBTs Q11 to Q14 will be described later.

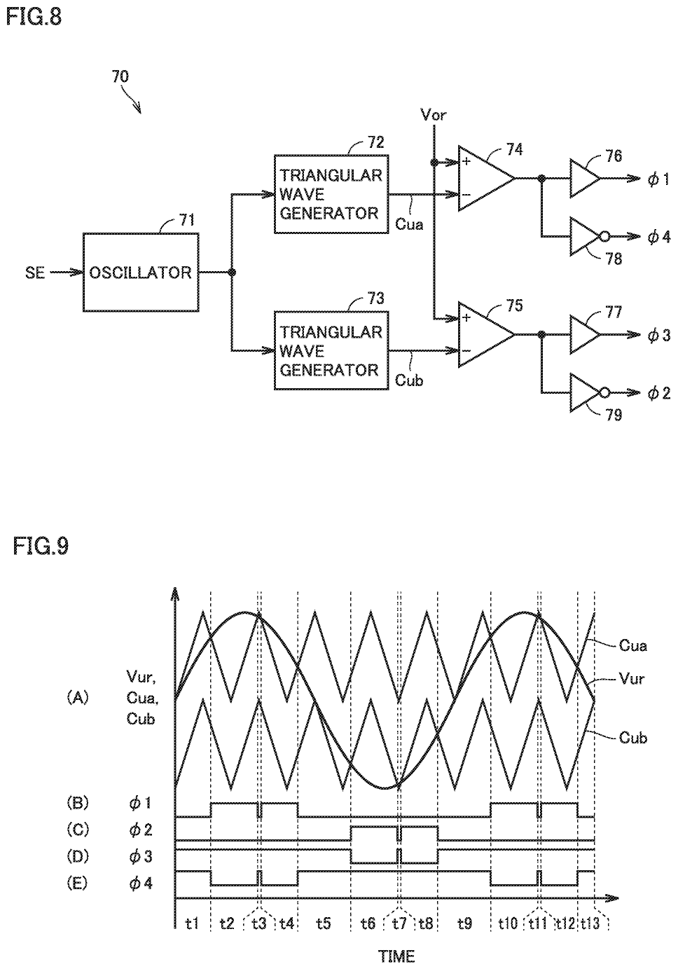

FIG. 8 is a circuit block diagram showing a configuration of a gate control circuit 70 for controlling inverter 62, which is compared with FIG. 3. In FIG. 8, gate control circuit 70 includes an oscillator 71, triangular wave generators 72 and 73, comparators 74 and 75, buffers 76 and 77, and inverters 78 and 79.

Oscillator 71 is an oscillator capable of controlling the frequency of an output clock signal (for example, a voltage-controlled oscillator). When mode selection signal SE is at the “H” level, oscillator 71 outputs a clock signal having frequency fH fully higher than the commercial frequency, and when mode selection signal SE is at the “L” level, oscillator 71 outputs a clock signal having frequency fL lower than frequency fH. Triangular wave generators 72 and 73 output triangular wave signals Cua and Cub, respectively, having the same frequency as that of the output clock signal of the oscillator.

Comparator 74 compares levels of voltage command value Vor from output current control circuit 36 (FIG. 2) and triangular wave signal Cua from triangular wave generator 72, and outputs a gate signal ϕ1 indicating the result of comparison. Buffer 76 provides gate signal ϕ1 to a gate of IGBT Q11. Inverter 78 inverts gate signal ϕ1 to generate a gate signal ϕ4 and provides gate signal ϕ4 to a gate of IGBT Q14.

Comparator 75 compares levels of voltage command value Vor from output current control circuit 36 and triangular wave signal Cub from triangular wave generator 73, and outputs a gate signal ϕ3 indicating the result of comparison. Buffer 77 provides gate signal ϕ3 to a gate of IGBT Q13. Inverter 79 inverts gate signal ϕ3 to generate a gate signal ϕ2 and provides gate signal ϕ2 to a gate of IGBT Q12.

FIGS. 9(A) to (E) show a time chart showing waveforms of voltage command value Vor, triangular wave signals Cua and Cub, and gate signals ϕ1 to ϕ4 shown in FIG. 8. As shown in FIG. 9(A), voltage command value Vor is a sinusoidal signal having the commercial frequency.

Triangular wave signal Cua has a minimum value of 0 V, and a maximum value higher than a positive peak value of voltage command value Vor. Triangular wave signal Cub has a maximum value of 0 V, and a minimum value lower than a negative peak value of voltage command value Vor. Triangular wave signals Cua and Cub are signals having the same phase, and the phase of triangular wave signals Cua and Cub is in synchronization with the phase of voltage command value Vor. The frequency of triangular wave signals Cua and Cub is higher than the frequency (commercial frequency) of voltage command value Vor.

As shown in FIGS. 9(A) and (B), when the level of triangular wave signal Cua is higher than the level of voltage command value Vor, gate signal ϕ1 is at an “L” level, and when the level of triangular wave signal Cua is lower than the level of voltage command value Vor, gate signal ϕ1 is at an “H” level. Gate signal ϕ1 is a positive pulse signal sequence.

During a period in which voltage command value Vor has positive polarity, the pulse width of gate signal ϕ1 increases as voltage command value Vor increases. During a period in which voltage command value Vor has negative polarity, gate signal ϕ1 is fixed to the “L” level. As shown in FIGS. 9(B) and (E), gate signal ϕ4 is an inverted signal of gate signal ϕ1.

As shown in FIGS. 9(A) and (C), when the level of triangular wave signal Cub is lower than the level of voltage command value Vor, gate signal ϕ2 is at an “L” level, and when the level of triangular wave signal Cub is higher than the level of voltage command value Vor, gate signal ϕ2 is at an “H” level. Gate signal ϕ2 is a positive pulse signal sequence.

During the period in which voltage command value Vor has positive polarity, gate signal ϕ2 is fixed to the “L” level. During the period in which voltage command value Vor has negative polarity, the pulse width of gate signal ϕ2 increases as voltage command value Vor decreases. As shown in FIGS. 9(C) and (D), gate signal ϕ3 is an inverted signal of gate signal ϕ2. Each of gate signals ϕ1 to ϕ4 is a PWM signal.

During periods in which gate signals ϕ1 and ϕ2 are at the “L” level and gate signals ϕ3 and ϕ4 are at the “H” level (t1, t3, t5, t7, t9, . . . ), IGBTs Q11 and Q12 are turned off and IGBTs Q13 and Q14 are turned on. Thereby, the neutral point voltage in DC line L3 is output to output node 62a via IGBTs Q14 and Q13.

During periods in which gate signals ϕ1 and ϕ3 are at the “H” level and gate signals ϕ2 and ϕ4 are at the “L” level (t2, t4, . . . ), IGBTs Q11 and Q13 are turned on and IGBTs Q12 and Q14 are turned off. Thereby, the positive DC voltage in DC line L1 is output to output node 62a via IGBT Q11.

During periods in which gate signals ϕ1 and ϕ3 are at the “L” level and gate signals ϕ2 and ϕ4 are at the “H” level (t6, t8, . . . ), IGBTs Q11 and Q13 are turned off and IGBTs Q12 and Q14 are turned on. Thereby, the negative DC voltage in DC line L2 is output to output node 62a via IGBT Q12.

When the waveforms of gate signals ϕ1 to ϕ4 change as shown in FIGS. 9(B) to (E), AC output voltage Vo having the same waveform as that of voltage command value Vur shown in FIG. 9(A) is output to between node N2 and neutral point NP. It should be noted that, although FIGS. 9(A) to (E) show the waveforms of voltage command value Vur and signals Cua, Cub, and ϕ1 to ϕ4 corresponding to the U phase, the same applies to the waveforms of the voltage command value and the signals corresponding to each of the V phase and the W phase. However, the voltage command values and the signals corresponding to the U phase, the V phase, and the W phase are out of phase with respect to each other by 120 degrees.

As can be seen from FIGS. 9(A) to (E), when the frequency of triangular wave signals Cua and Cub is increased, the frequency of gate signals ϕ1 to ϕ4 increases, and the switching frequency of IGBTs Q11 to Q14 (the number of times of turning on and off per second) increases. When the switching frequency of IGBTs Q11 to Q14 increases, switching losses occurring in IGBTs Q11 to Q14 increase, causing a reduction in the efficiency of the uninterruptible power supply device. However, when the switching frequency of IGBTs Q11 to Q14 increases, the voltage fluctuation rate of AC output voltage Vo decreases, and high-quality AC output voltage Vo is obtained.

In contrast, when the frequency of triangular wave signals Cua and Cub is decreased, the frequency of gate signals ϕ1 to ϕ4 decreases, and the switching frequency of IGBTs Q11 to Q14 decreases. When the switching frequency of IGBTs Q11 to Q14 decreases, switching losses occurring in IGBTs Q11 to Q14 decrease, achieving an improved efficiency of the uninterruptible power supply device. However, when the switching frequency of IGBTs Q11 to Q14 decreases, the voltage fluctuation rate of AC output voltage Vo increases, and the waveform of AC output voltage Vo is deteriorated.

Accordingly, in the second embodiment, there are provided the normal operation mode in which the frequency of triangular wave signals Cua and Cub is set to relatively high frequency fH to decrease the voltage fluctuation rate, and the power saving operation mode in which the frequency of triangular wave signals Cua and Cub is set to relatively low frequency fL to decrease switching losses, as in the first embodiment. A user of the uninterruptible power supply device can select a desired mode from the normal operation mode and the power saving operation mode, using operation unit 17.

Next, a method of using the uninterruptible power supply device and operation thereof will be described. First, a description will be given of a case where load 24 is a load having a small acceptable range for the voltage fluctuation rate (that is, a load which cannot be driven by AC input voltage Vi from commercial AC power supply 21). In this case, the user of uninterruptible power supply device 1 operates operation unit 17 to select the normal operation mode.

Since the normal operation mode is selected and mode selection signal SE is set to the “H” level, in gate control circuit 70 (FIG. 8), triangular wave signals Cua and Cub having relatively high frequency fH are generated by oscillator 71 and triangular wave generators 72 and 73.

Voltage command value Vor is compared with triangular wave signal Cua by comparator 74, and gate signals ϕ1 and ϕ4 are generated by buffer 76 and inverter 78. Voltage command value Vor is compared with triangular wave signal Cub by comparator 75, and gate signals ϕ3 and ϕ2 are generated by buffer 77 and inverter 79.

During the period in which voltage command value Vur has positive polarity, IGBTs Q12 and Q13 of inverter 62 (FIG. 7) are fixed to an OFF state and an ON state, respectively, and IGBT Q11 and IGBT Q14 are alternately turned on. During the period in which voltage command value Vur has negative polarity, IGBTs Q11 and Q14 are fixed to an OFF state and an ON state, respectively, and IGBT Q12 and IGBT Q13 are alternately turned on by gate signals ϕ2 and ϕ3, generating AC output voltage Vo having three levels.

Since IGBTs Q11 to Q14 of inverter 62 are controlled at relatively high frequency fH in the normal operation mode, high-quality AC output voltage Vo having a relatively small voltage fluctuation rate can be generated. However, relatively large switching losses occur in IGBTs Q11 to Q14, causing a reduction in the efficiency of the uninterruptible power supply device.

Next, a description will be given of a case where load 24 is a load having a large acceptable range for the voltage fluctuation rate (that is, a load which can be driven by AC input voltage Vi from commercial AC power supply 21). In this case, the user of the uninterruptible power supply device operates operation unit 17 to select the power saving operation mode.

Since the power saving operation mode is selected and mode selection signal SE is set to the “L” level, in gate control circuit 70 (FIG. 8), triangular wave signals Cua and Cub having relatively low frequency fL are generated by oscillator 71 and triangular wave generators 72 and 73, and gate signals ϕ1 to ϕ4 are generated using triangular wave signals Cua and Cub. In inverter 62, IGBTs Q11 to Q14 are driven by gate signals ϕ1 to ϕ4 to generate AC output voltage Vo.

Since IGBTs Q11 to Q14 of inverter 62 are controlled at relatively low frequency fL in the power saving operation mode, the voltage fluctuation rate of AC output voltage Vo relatively increases. However, since load 24 having a large acceptable range for the voltage fluctuation rate of AC output voltage Vo is driven, load 24 can be driven without problems even when the voltage fluctuation rate of AC output voltage Vo increases. In addition, switching losses occurring in IGBTs Q11 to Q14 decrease, achieving an improved efficiency. Since other configuration and operation are the same as those in the first embodiment, the description thereof will not be repeated.

As described above, in the second embodiment, there are provided the normal operation mode in which the frequency of triangular wave signals Cua and Cub is set to relatively high frequency fH, and the power saving operation mode in which the frequency of triangular wave signals Cua and Cub is set to relatively low frequency fL, and a selected mode is performed. Therefore, by selecting the power saving operation mode in the case of driving load 24 having a large acceptable range for the voltage fluctuation rate of AC output voltage Vo, switching losses occurring in IGBTs Q11 to Q14 of inverter 62 can be decreased, achieving an improved efficiency of uninterruptible power supply device 1.

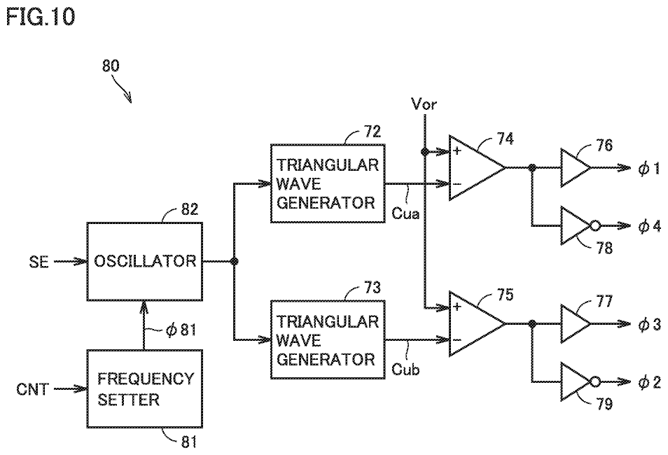

FIG. 10 is a circuit block diagram showing a modification of the second embodiment, which is compared with FIG. 8. This modification is different from the second embodiment in that a gate control circuit 80 replaces gate control circuit 70. In gate control circuit 80, a frequency setter 81 and an oscillator 82 replace oscillator 71 of gate control circuit 70.

In this modification, frequency fL of triangular wave signals Cua and Cub in the power saving operation mode can be set to a desired value by operating operation unit 17. Frequency setter 81 outputs a signal ϕ81 indicating set frequency fL, based on control signal CNT from operation unit 17.

When mode selection signal SE is at the “H” level, oscillator 82 outputs a clock signal having relatively high frequency fH, and when mode selection signal SE is at the “L” level, oscillator 82 outputs a clock signal having frequency fL designated by signal ϕ81. Triangular wave generators 72 and 73 output triangular wave signals Cua and Cub, respectively, having the same frequency as that of the output clock signal of oscillator 82. In this modification, the same effect as that of the second embodiment is obtained, and in addition, frequency fL of triangular wave signals Cua and Cub in the power saving operation mode can be set to a desired value, according to the type of load 24.

It should be understood that the embodiments disclosed herein are illustrative and non-restrictive in every respect. The present invention is defined by the scope of the claims, rather than the description above, and is intended to include any modifications within the scope and meaning equivalent to the scope of the claims.

### REFERENCE SIGNS LIST

1: uninterruptible power supply device; T1: AC input terminal; T2: bypass input terminal; T3: battery terminal; T4: AC output terminal; 2, 8, 14, 16: electromagnetic contactor; 3, 11: current detector; 4, 9, 9a, 9b, 13: capacitor; 5, 12: reactor; 6, 60: converter; 7, 61: bidirectional chopper; 10, 45, 62, 78, 79: inverter; 15: semiconductor switch; 17: operation unit; 18: control device; 21: commercial AC power supply; 22: bypass AC power supply; 23: battery; 24: load; 31: reference voltage generation circuit; 32: voltage detector; 33, 35: subtractor; 34: output voltage control circuit; 36: output current control circuit; 37, 50, 70, 80: gate control circuit; 41, 52, 71, 82: oscillator; 42, 72, 73: triangular wave generator; 43, 74, 75: comparator; 44, 76, 77: buffer; 51, 81: frequency setter.

1. A power conversion device comprising:
an inversion unit including a plurality of switching elements and configured to convert DC power into AC power having a commercial frequency and supply the AC power to a load; and
a control device configured to compare levels of a sinusoidal signal having the commercial frequency and a triangular wave signal having a frequency higher than the commercial frequency, and generate a control signal for controlling the plurality of switching elements based on a result of comparison,
the control device being configured to perform a mode selected from a first mode in which the frequency of the triangular wave signal is set to a first value and a second mode in which the frequency of the triangular wave signal is set to a second value smaller than the first value, the second value is set such that a voltage fluctuation rate of an output voltage of the inversion unit is less than or equal to a voltage fluctuation rate of the AC voltage supplied from the commercial AC power supply.

2. The power conversion device according to claim 1, wherein
the first mode is selected when normal operation of the power conversion device is performed, and
the second mode is selected when the load can be driven by an AC voltage supplied from a commercial AC power supply, to reduce switching losses occurring in the plurality of switching elements.

3. (canceled)

4. The power conversion device according to claim 1, wherein
the control device includes
a voltage command unit configured to generate the sinusoidal signal to eliminate a deviation between an output voltage of the inversion unit and a reference voltage,
a triangular wave generator configured to generate the triangular wave signal having the frequency set to the first or second value, and
a comparator configured to compare the levels of the sinusoidal signal and the triangular wave signal, and generate the control signal based on the result of comparison.

5. The power conversion device according to claim 1, further comprising a selection unit configured to select a desired mode from the first and second modes, wherein
the control device is configured to perform the mode selected by the selection unit.

6. The power conversion device according to claim 1, further comprising a setting unit configure to set the second value to a desired value smaller than the first value, wherein
the control device is configured to compare the levels of the sinusoidal signal and the triangular wave signal having the frequency with the second value set by the setting unit.

7. The power conversion device according to claim 1, further comprising a conversion unit configured to convert AC power supplied from a commercial AC power supply into DC power, wherein
during a normal state in which the AC power is supplied from the commercial AC power supply, the DC power generated by the conversion unit is supplied to the inversion unit and is also stored in a power storage device, and
during a power failure in which supply of the AC power from the commercial AC power supply is stopped, the DC power in the power storage device is supplied to the inversion unit.
